(19) United States
(12) Patent Application Publication
(10) Pub. No.: US 2013/0104073 A1
(43) Pub. Date: Apr. 25, 2013

(54) IMMERSIVE VIDEO INTELLIGENCE NETWORK

(71) Applicants: John R. Bowditch, Athens, OH (US); Stephen D. Mokris, Athens, OH (US); John E. Gibson, Westerville, OH (US); Roger Good, Athens, OH (US)

(72) Inventors: John R. Bowditch, Athens, OH (US); Stephen D. Mokris, Athens, OH (US); John E. Gibson, Westerville, OH (US); Roger Good, Athens, OH (US)

(73) Assignee: OHIO UNIVERSITY, Athens, OH (US)

(21) Appl. No.: 13/805,933

(22) PCT Filed: Jun. 22, 2011
(86) PCT No.: PCT/US11/41437

§ 371 Date: Dec. 20, 2012

Related U.S. Application Data
(60) Provisional application No. 61/357,350, filed on Jun. 22, 2010.

(51) Int. Cl. G06T 17/05; G06F 3/0481

(52) U.S. Cl. CPC G06T 17/05; G06F 3/04815
USPC 715/782; 345/420

(57) ABSTRACT

A method of providing a navigable environment of an indoor space. The indoor space includes a plurality of rooms 18-30, which are optionally mapped to a floor plan 12. The method includes acquiring a plurality of images 60, 62 that are associated with the plurality of rooms 18-30 of the indoor space. At least a portion of the plurality of images 60, 62 are combined into at least two panoramic views 74 for each room 18-30 and rendered into a model of the indoor space. A three-dimensional model is defined from the rendered model and graphically illustrated as a three-dimensional navigable representation with a graphics engine so that a first user may navigate the indoor space.

### STATEMENT REGARDING FEDERALLY-SPONSORED RESEARCH OR DEVELOPMENT

This invention was made, at least in part, with support from the U.S. Government under the Urban Area Security Initiative with Federal Pass-Through Funds identified as 2008-GE-T8-0025 and 2007-GE-T7-0030, which were awarded by the U.S. Department of Homeland Security. The U.S. Government has certain rights in the invention.

### FIELD OF THE INVENTION

The present invention relates generally to computing systems, and, in particular, to a method of using a computing system to create a three-dimensional photorealistic model.

### BACKGROUND OF THE INVENTION

Conventional digital representations of an interior view of a space (i.e., a room) are often limited to one of two options: an artistic rendering (such as architectural models) or a distorted “bubble” panorama. Artistic renderings are often inartful at displaying the actual layout of the interior. This is largely because artistic renderings are incapable of taking into account subsequent architectural changes that may have occurred and often fail to take into account actual objects, such as desks, chairs, bookshelves, cubicles, light fixtures, and so forth. Bubble panoramas provide a distorted view of the space because the image is mapped onto a curved surface. The curved surface not only distorts the actual architecture of the space, but also the objects within the space. While bubble panoramas often allow the user to view the space by rotating with respect to a specific point within the bubble, the user cannot move freely within the space.

While artistic renderings and bubble panorama images may be appropriate for esthetic purposes or for creating a keepsake/memento, these representations have very little to offer by way of intelligence for those persons charged with responding to emergencies (i.e., first responders), maintaining the facilities, or maintaining the public safety (i.e., “public safety managers”). That is, these representations, with or without accompanying space blueprints, may not provide sufficient detail for the first responders and/or the public safety managers to fully assess situations or prepare a response strategy. For example, during a hostage situation the first responders have conventionally relied on blueprint and photographs to determine angles of attack, positions for hiding or observation, and so forth. However, blueprints and photographs are incomplete with respect to the positioning of objects (for example, plants, desks, cubical walls, and so forth) within the space. The unexpected absence, presence, dimensions, and location of these may hinder a rescue operation if unknown to the responders.

By way of another example, the U.S. Department of Homeland Security has placed much emphasis on training public service personnel for responding to natural disasters and terrorist attacks. In many instances, training must be performed on location in order to provide a realistic experience to the personnel. However, this requires the personnel to work after hours when civilians (or those not participating in the training) are not present. Alternatively, the location is closed to civilians during normal business hours, which causes loss of revenue. Thus, there remains a need for a method that can convert a tangible and real space into a three-dimensional, navigable representation.

### SUMMARY OF THE INVENTION

The present invention overcomes the foregoing problems and other shortcomings, drawbacks, and challenges of developing a truly multi-modal vehicle. While the invention will be described in connection with certain embodiments, it will be understood that the invention is not limited to these embodiments. To the contrary, this invention includes all alternatives, modifications, and equivalents as may be included within the spirit and scope of the present invention.

In accordance with one embodiment of the invention a method of providing a navigable environment of an indoor space is described. The indoor space includes a plurality of rooms, which are mapped to a floor plan. The method includes acquiring a plurality of images that are associated with the plurality of rooms of the indoor space. At least a portion of the plurality of images are combined into at least two panoramic views for each room and rendered into a model of the indoor space. A three-dimensional model is defined from the rendered model and graphically illustrated as a three-dimensional navigable representation, with a graphics engine, so that a first user may navigate the indoor space.

Another embodiment of the invention is directed to a method of providing a navigable environment of an indoor space. The indoor space includes a plurality of rooms, which are mapped to a floor plan. The method includes providing an indication of a first user to a computing system. If the first user is a valid user, then a three-dimensional navigable representation of a model of the indoor space is graphically illustrated for the first user with a graphics engine. The model includes at least two rendered panoramic views of the plurality of rooms. The first user navigates the indoor space.

In accordance with another embodiment of the invention, a method of combining a plurality of images into at least two panoramic images of an indoor space is described. The indoor space includes a plurality of rooms, which are mapped to a floor plan. In accordance with the method, a plurality of images associated with the plurality of rooms is received. From information associated with the plurality of images, a subset of the plurality of images are automatically determined and used to create the at least two panoramic images of at least one of the plurality of rooms. At least one feature from first and second ones of the plurality of images of at least one of the plurality of rooms is automatically matched so that the first and second ones of the plurality of images are automatically merged.

In still another embodiment of the invention, a method of providing a navigable environment of an indoor space is described. The indoor space includes a plurality of rooms, which are mapped to a floor plan. The method includes graphically illustrating a three-dimensional navigable representation of a rendered model with a graphics engine. The model includes at least two rendered panoramic views of the plurality of rooms. A user navigates the indoor space.

In another embodiment of the invention, an apparatus is described. The apparatus includes at least one processing unit and a method containing a program code. The program code is configured to perform a method in accordance with one embodiment of the invention.

Yet another embodiment of the invention is directed to a program product. The program product includes program code that is configured to be executed by at least one processing unit to perform a method in accordance with one embodiment of the invention. The program product further includes a computer readable medium bearing the program code.

In accordance with yet another exemplary embodiment of the invention, a method of training a first person with respect to an event within an indoor space is described. The method includes loading a three-dimensional navigable representation of the indoor space. The indoor space includes a plurality of rooms, which are mapped to a floor plan. The three-dimensional navigable representation is created by graphically illustrating a rendered model with a graphics engine. The model includes at least two rendered panoramic views of the plurality of rooms. The event is then simulated in the indoor space.

In accordance with still another embodiment of the invention, a method of creating a model of an indoor space for entertaining one or more interactive players is described. The method includes loading a three-dimensional navigable representation of the indoor space. The indoor space includes a plurality of rooms, which are mapped to a floor plan. The three-dimensional navigable representation is created by graphically illustrating a rendered model with a graphics engine. The model includes at least two rendered panoramic views of the plurality of rooms. The one or more interactive players are simulated within the indoor space such that the players may interact with one another or with the indoor space.

The above and other objects and advantages of the present invention shall be made apparent from the accompanying drawings and the description thereof.

### BRIEF DESCRIPTIONS OF THE DRAWINGS

The accompanying drawings, which are incorporated in and constitute a part of this specification, illustrate embodiments of the invention and, together with a general description of the invention given above, and the detailed description of the embodiments given below, serve to explain the principles of the invention.

FIG. 1 is a flow chart illustrating one exemplary method of creating an immersive video intelligence network system.

FIG. 2 is an example of a blueprint for an interior space for use in creating the immersive video intelligence network system.

FIG. 3 is a diagrammatic view of a computer system suitable for creating the immersive video intelligence network system in accordance with one embodiment of the invention.

FIGS. 4A and 4B are diagrammatic views of an exemplary image set at two different exposures of a room within the blueprint of FIG. 2.

FIG. 5 is a panoramic image created from the exemplary image set of FIG. 4A.

FIG. 6 is a flow chart illustrating one exemplary method of using the immersive video intelligence network system.

### DETAILED DESCRIPTION OF THE INVENTION

Embodiments of the invention provide an immersive video intelligence network (“IVIN”) system that is utilized to create digitally navigable 3-D photorealistic models (i.e., “digital representation”) of an indoor space with synchronized visualization of movement on a floor plan. While the invention will be described with reference to the indoor space, one of ordinary skill in the art will readily appreciate the methods described herein are equally applicable to outdoor spaces as well.

The IVIN system is accessed through a user-friendly interface via a user device (e.g., a computing system, and more particularly a non-mobile computing system, such as a desktop, or a mobile computing system, such as a laptop, tablet-type computing system, or smart phone). The IVIN system allows a player (i.e., the user of the digital representation) to navigate freely within the digital representation of the indoor space and to interact with the objects within that digital representation, much like a video game environment. Specifically, the IVIN system provides a photorealistic, 360° views from any position in the floor plan while taking into account, and preventing, possible distortions of the view.

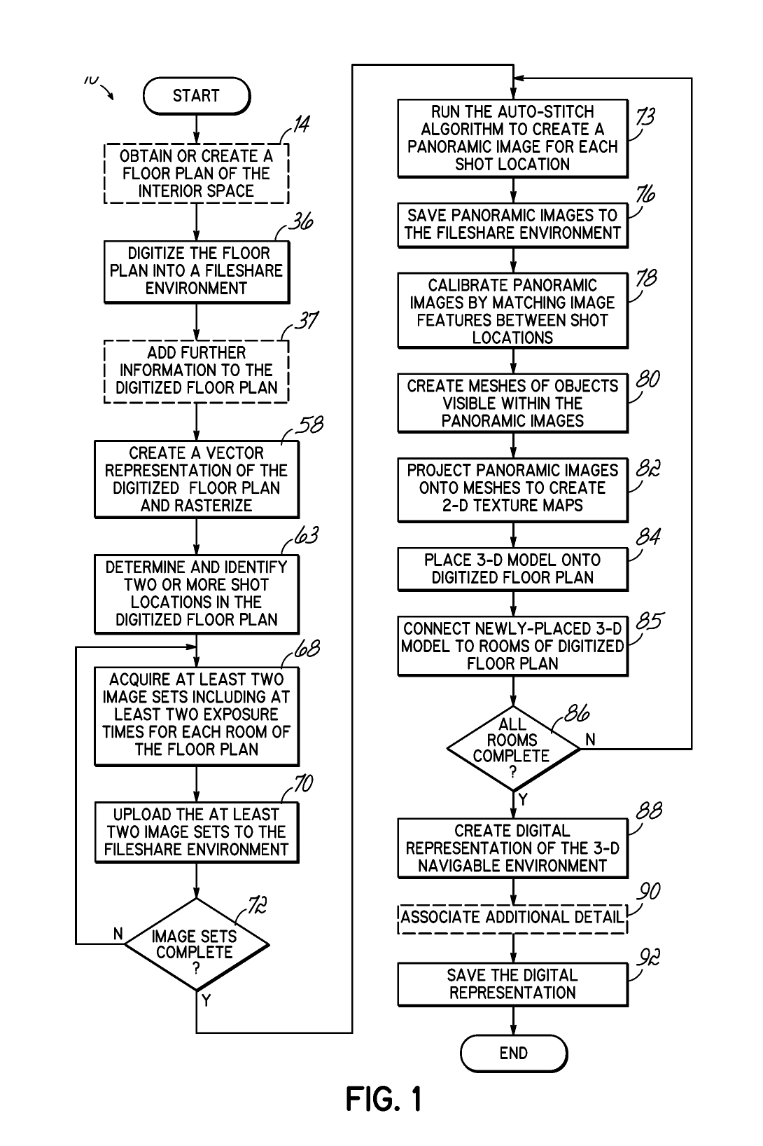

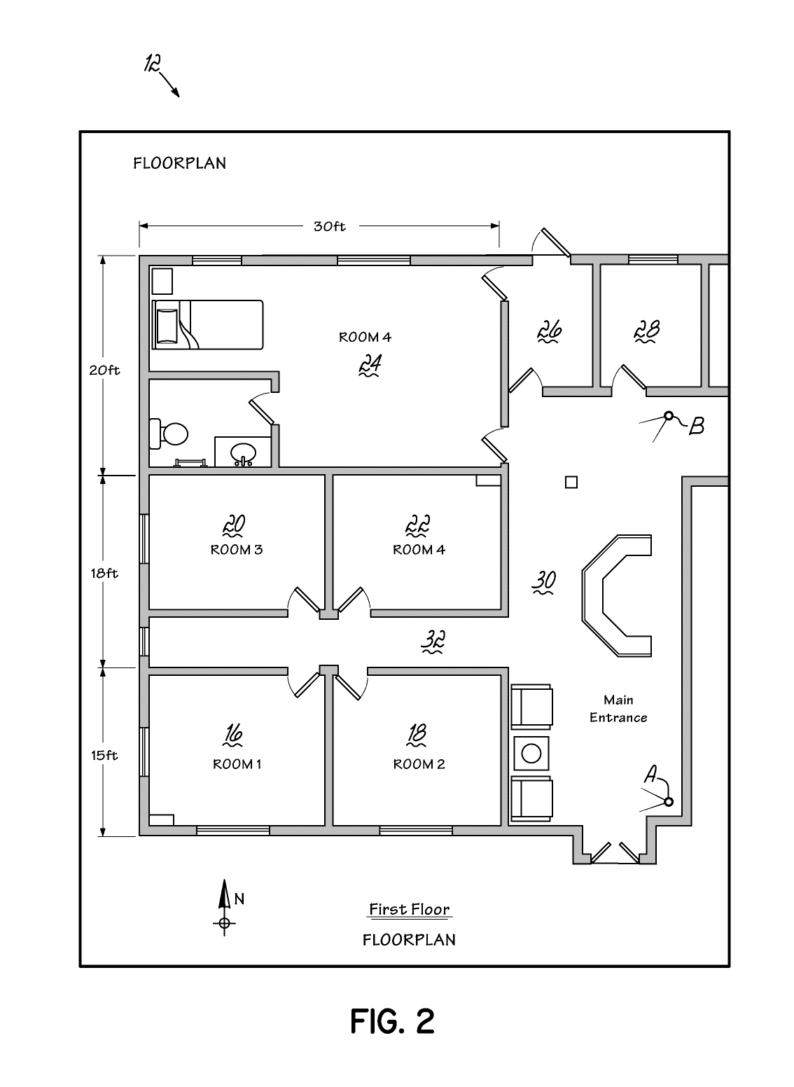

Turning now to the figures, and in particular to FIG. 1, which is a flow chart illustrating one method 10 of creating the digital representation of the interior space. While not necessary, the method is facilitated by obtaining or creating a floor plan 12 (FIG. 2) for a particular interior space (Block 14). The interior space may be an open space or the interior space may be divided into two or more separate, individual spaces, such as in an office complex or a floor of a building. In the latter, and for convenience of description, the two or more spaces are referred to as “room,” which may include any discrete space, e.g., an office, a cubicle, an elevator, a closet, at least a portion of a hallway, a vestibule, and stairwells, just to name a few examples. The floor plan 12 may be generated from blueprints and architectural drawings of the interior space. For example, the floor plan 12 (FIG. 2) represents an office floor that includes eight separate rooms 18, 20, 22, 24, 26, 28, 30, and a connecting hallway 32. While not shown in the floor plan 12, each room 18-30 may include one or more objects, such as desks, chairs, end tables, bookshelves, plants, and so forth.

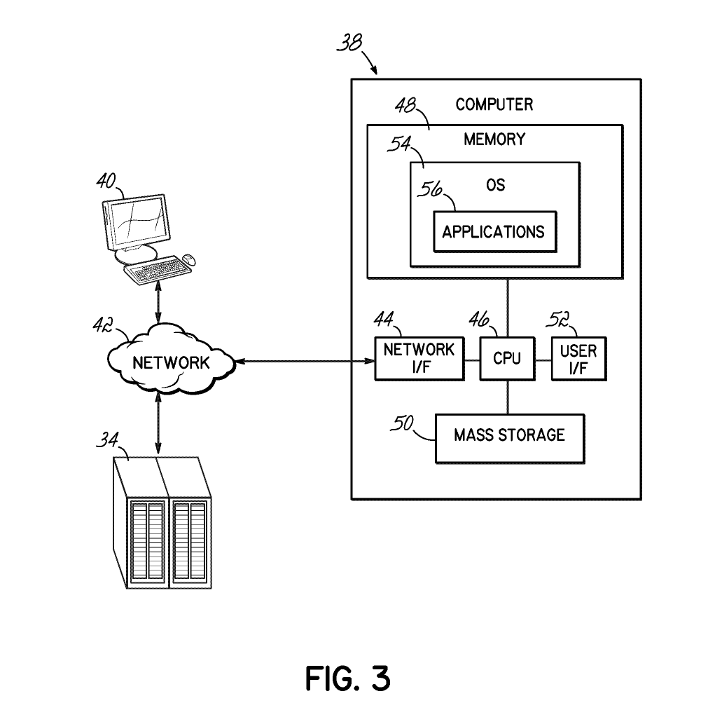

In Block 36, the floor plan 12 (FIG. 2) is digitized into a fileshare environment 34 (FIG. 3). Further data may be added to the floor plan 12, if desired, in Block 37, including the size of each room 18-30, distances within the floor plan 12 (FIG. 2), GPS coordinates, and labels for rooms (for example, “Mr. J. Doe's Office”).

Turning now to FIG. 3, the details of the computer 38 are described. The computer that is shown in FIG. 3 may be considered to represent any type of computer, computer system, computing system, server, disk array, or programmable device such as multi-user computers, single-user computers, handheld devices, networked devices, or embedded devices, etc. The computer 38 may be implemented with one or more networked computers 40 using one or more networks 42, e.g., in a cluster or other distributed computing system through a network interface (illustrated as “NETWORK I/F 44”). The computer 38 may operably coupled to the fileshare environment 36, which may be a networked mass storage device. For brevity's sake, the computer 38 will be referred to simply as “computer,” although it should be appreciated that the term “computing system” may also include other suitable programmable electronic devices consistent with embodiments of the invention.

The computer 38 typically includes at least one processing unit (illustrated as “CPU 46”) coupled to a memory 48 along with several different types of peripheral devices, e.g., a mass storage device 50, a user interface (illustrated as “User I/F 52”), and the Network I/F 44. The memory 48 may include dynamic random access memory (DRAM), static random access memory (SRAM), non-volatile random access memory (NVRAM), persistent memory, flash memory, at least one hard disk drive, and/or another digital storage medium. The mass storage device 50 is typically at least one hard disk drive and may be located externally to the computer 38, such as in a separate enclosure or in one or more networked computers 40, one or more networked storage devices (such as the fileshare environment 34, for example, a server).

The CPU 46 may be, in various embodiments, a single-thread, multi-threaded, multi-core, and/or multi-element processing unit (not shown) as is well known in the art. In alternative embodiments, the computer 38 may include a plurality of processing units that may include single-thread processing units, multi-threaded processing units, multi-core processing units, multi-element processing units, and/or combinations thereof as is well known in the art. Similarly, the memory 48 may include one or more levels of data, instruction, and/or combination caches, with caches serving the individual processing unit or multiple processing units (not shown) as is well known in the art.

The memory 48 of the computer 38 may include an operating system (illustrated as “OS 54”) to control the primary operation of the computer 38 in a manner that is well known in the art. The memory 48 may also include at least one application 56, component, algorithm, program, object, module or sequence of instructions, or even a subset thereof, will be referred to herein as “computer program code” or simply “program code.” Program code typically comprises one or more instructions that are resident at various times in the memory 48 and/or the mass storage device 50 of the computer 38, and that, when read and executed by the CPU 46, causes the computer 38 to perform the steps necessary to execute steps or elements embodying the various aspects of the invention. For example, a vector representation of the digitized floor plan from Block 36 may be created and rasterized with an appropriate application, for example, Adobe Illustrator as distributed by Adobe Systems Incorporated of Mountain View, Calif. (Block 58 of FIG. 1). While the creating of the vector representation has been specifically illustrated in Block 58, it would be understood that this creating of the vector representation may occur at any time prior to placing a later created three dimensional model onto the digitized floor plan (see Block 84 below).

Those skilled in the art will recognize that the environment illustrated in FIG. 3 is not intended to limit the present invention. Indeed, those skilled in the art will recognize that other alternative hardware and/or software environments may be used without departing from the scope of the invention.

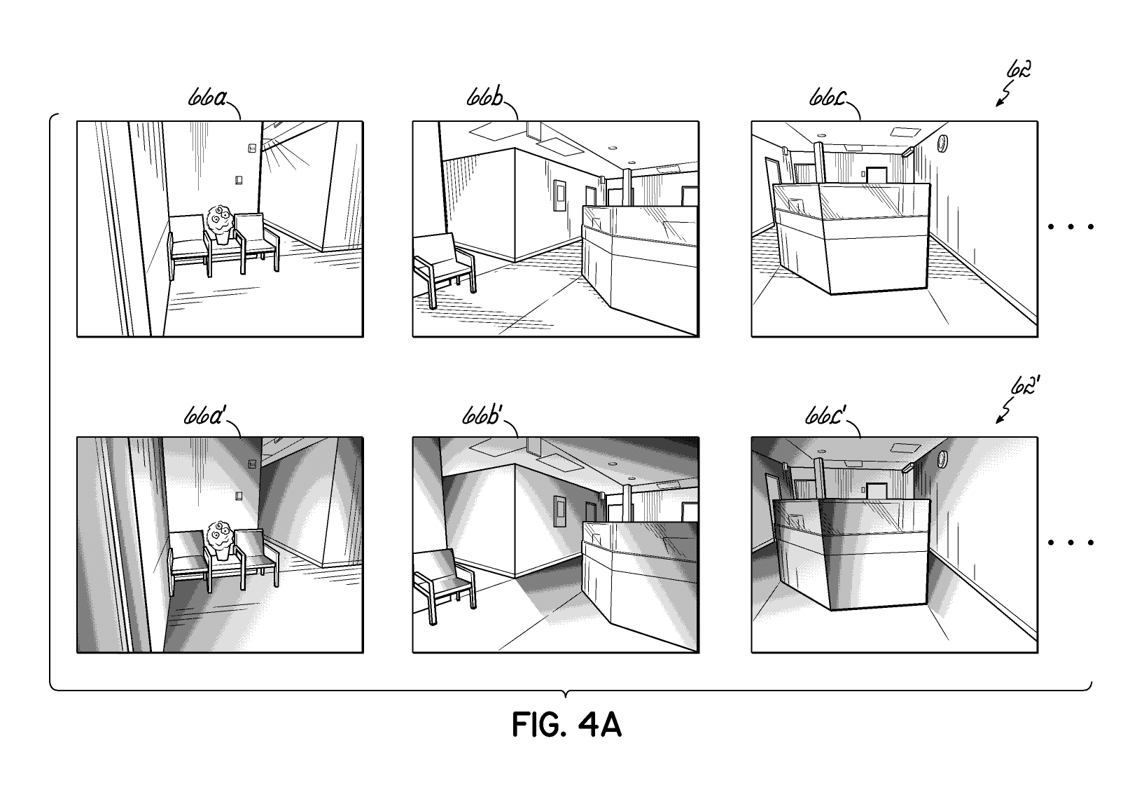

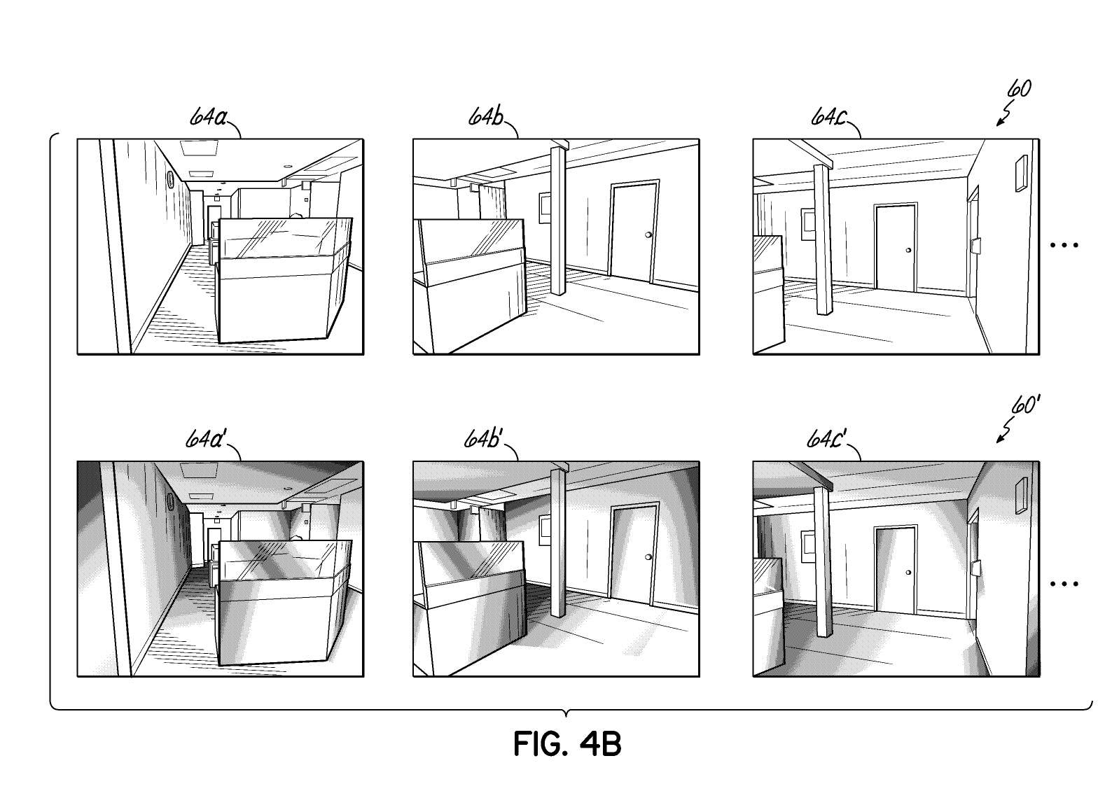

Turning now to FIGS. 4A and 4B, with reference still to FIGS. 1 and 2, at least two image sets 60, 62 are acquired from at least two different positions within a room. For example, in the floor plan 12 of FIG. 2, a first room 30 may be designated a reception area. Two shot locations (designated by “A” and “B”) are determined, selected, or otherwise identified within from the first room 30 from which the respective image set 60, 62 is acquired (Block 63). Acquisition of the image sets for each room 18-30 of the floor plan 12, as indicated in Block 68, may include operation of a camera, which may be a digital single-lens reflex camera, positioned at each shot location A, B. Suitable commercially-available cameras include those, for example, that are distributed by CANON Inc. or NIKON Corporation, both of Tokyo, Japan. The camera may be bracketed for high dynamic range and utilize a fish-eye lens. Other embodiments may utilize a camera incorporated into a smart phone, for example, the IPHONE distributed by Apple, Inc. of Cupertino, Calif. The camera may be disposed upon a NODAL NINJA panoramic tripod head, as distributed by Bill Baily, L.L.C., d.b.a. Nodal Ninja, of Chandler, Ariz.

Each acquired image set 60, 62 includes at least six images (referred to as segments 64a, 64b, 64d, 66a, 66b, 66d) having overlapping field of views and ranging from floor-to-ceiling and shot with at least two different exposures, as shown by the image series 60′, 62′ including images 64a′, 64b′, 64c′, 66a′, 66b′, 66c′ (where similar photographs of different exposure time indicated with a prime). Selection of the number and exposure times is known to those skilled in the art of photogrammetry, which is a method of determining the geometric properties of an object within a photographic image. Though not shown, each image set 60, 62 may include additional shots based upon the layout and/or objects within the first room 30 (e.g., such as if there is a desk blocking at least a portion of a wall or floor). Further, each segment 64a-64c, 66a-66ccomprising the image set 60, 62 may be associated with specific image data, such as corresponding shot location A, B on a floor plan 12, the direction of the shot, and the exposure time, and so forth. The image data may be recorded by a separate computing system, such as the IPHONE distributed by Apple, Inc. of Cupertino, Calif.

The at least two image sets 60, 62 with the image data are then uploaded to the fileshare environment 34 (Block 70) and checked for quality assurance (Inquiry 72). As to the upload, if entire floor plan 12 (FIG. 2) is to be modeled, then at least two image sets 60, 62 are required for each room 18-30 and the hallway 32 (for convenience, the rooms 18-30 and the hallway are hereafter referred to as “ the rooms 18-32”) of the floor plan 12. The at least two image sets of each room 18-32 may be grouped together and may be saved to an individual file folder (“a room folder”) designated for each respective room 18-32. As to the quality assurance, the Inquiry 72 includes procedures to ensure that the segments 64a-64d, 66a-66c of each image set 60, 62 is of a sufficient quality, to ensure that the correct images and number thereof have been acquired, to ensure an adherence to naming conventions, and to ensure that there is no data corruption. If the image sets 60, 62 are not complete (“No” branch of Inquiry 72), then the procedure returns for the acquisition of additional images at Block 68.

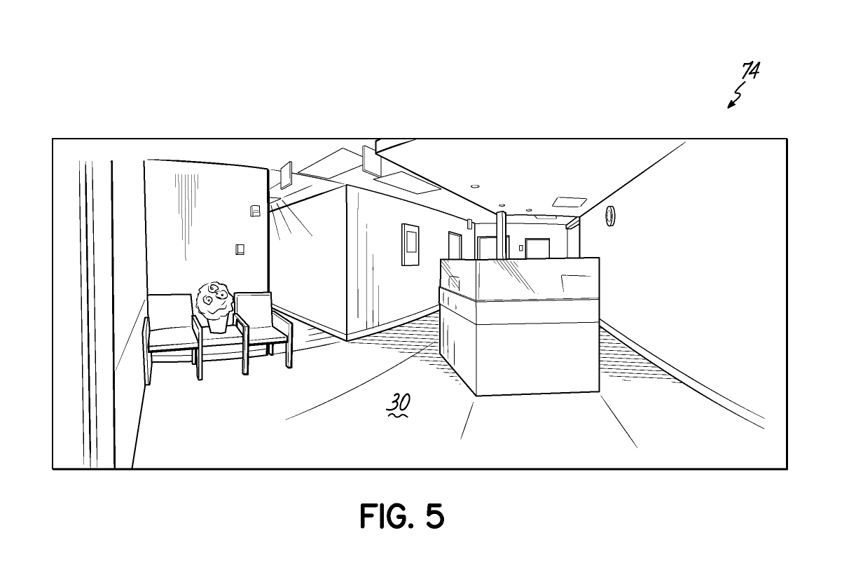

If the image sets 60, 62 are complete (“Yes” branch of Inquiry 72), then the segments 64a-64c, 66a-66c of each image set 60, 62 are then stitched together using an automatic stitching algorithm (“autostitch algorithm”). The autostitch algorithm analyzes each segment 64a-64c, 66a-66c for its location, direction, and its associated image data. Specifically, the autostitch algorithm determines how many segments 64a-64c, 66a-66c are included in each image set 60, 62. If at least six shots have not been taken, then the autostitch algorithm may declare an error. If at least six shots have been taken, then the autostitch algorithm unwraps the images (to compensate for fisheye lens distortion), masks the segments 64a-64c, 66a-66c, and blends the segments 64a-64c, 66a-66c according to structures and/or components within the segments 64a-64c, 66a-66c (e.g., straight line portions, curvilinear portions, edges) as well as its corresponding image data (e.g., identifying the direction and/or number in a sequence the segment was taken). If at least 12 or 18 segments 64a-64c, 66a-66c have been acquired, then the autostitch algorithm fuses the segments 64a-64c, 66a-66c together for the widest range of exposure then unwraps, masks, and blends the segments 64a-64c, 66a-66c. The unwrapping, masking, and blending of the segments 64a-64c, 66a-66c for the first room 30 create a panoramic image 74 of each shot location A, B (Block 73). FIG. 5 is one example of an unwrapped, masked, and blended panorama resulting from images 66a-66c of the shot location A.

In some embodiments, the autostitch algorithm may also take into account and addresses various factors individual to the cameras and lenses (as each is slightly different and provides slightly different data flaws), as well as lens aperture settings, shutter settings, and/or additional settings to ensure stable quality of image stitching. In still other embodiments, any of the segments 64a-64c, 66a-66c and/or the panoramic image 74 may be adjusted, as necessary, for example, using Adobe Photoshop, which is also distributed by Adobe Systems Incorporated.

With the panoramic image 74, in conjunction with the panoramic image created from shot location B and possibly other slot locations (not shown), is then modeled in photogrammetry software (for example, ImageModeler by AutoDesk) to create meshes and textures of the first room 30. Specifically, the panoramic image 74 may be calibrated to panoramic images 74 that are shot from other locations within the same room, so that the panoramic images 74 and the first room 30 reference the same points or image features within the panoramic image 74 from each of the shot locations A, B (Block 78). Still more specifically, multiple points or regions (e.g., a straight line portion, curvilinear portion, an edge, a room corner, a door frame, etc.) in the panoramic image 74 are correlated to the same points in other panoramic images 74 of the same room. In Block 80, meshes of objects corresponding to objects (such as desks, bookshelves, water coolers, wall hangings, etc.) captured in the panoramic image 74 (shot location A) and panoramic images 74 from other shot locations (for example, location B) are created. If necessary, the additional acquired images of these (or similar) objects may be added to define views of the room and/or objects therein, as well as add realistic textures to the objects and/or other portions of the room (such as the objects, walls, floor, carpet, ceiling, etc.). The calibrated panoramic images may then be projected onto the meshes in order to create 2-D texture maps (Block 82).

A 3-D model of the first room 30 is created that includes the various objects found within the first room 30, if any, and configured to be imported to a digital representation. The 3-D model of the first room 30 is then resized to a power of two-square for use in the digital representation and touched up, if necessary.

With the 3-D model of the first room 30 created, the 3-D model is placed onto the vectored, digitized floor plan 12 in the corresponding location of the fileshare environment 34 using another computer program, for example, AUTODESK MAYA, distributed by Autodesk, Inc. of Mill Valley, Calif. (Block 84). The newly-placed 3-D model is then connected to the rooms 18-30 of the digitized floor plan 12 (Block 85).

An Inquiry (Block 86) determines whether all of the other rooms 18-28, 32 of the floor plan 12 have been completed and are ready for incorporation into the digital representation. If the preparation of a 3-D model and a 2-D texture map is complete for all of the necessary or desired rooms (“Yes” branch of Inquiry 86), then the process continues; otherwise (“No” branch of Inquiry 86), the process returns to create panoramic images of the other rooms 18-28, 32. At least a portion of the 3-D model is then imported into a graphics engine (e.g., a game engine) such that a navigable floor plan may be built. In particular embodiments, the 3-D floor plan is added to a suitable computer program, such as Unity3D game engine, distributed by Unity Technologies of San Francisco, Calif., to create a 3-D navigable environment. In this manner, the rooms 18-32 are associated with each other and imported into the game engine such that a player may move through the 3-D navigable environment as a virtual indoor environment and interact with objects therein. Such interaction may include, for example, interacting with a door and navigating around an object.

In some embodiments, additional data may be associated with the 3-D navigable environment such that the additional data may be displayed as the player navigates throughout the 3-D navigable environment (Block 90). This additional data may include a map of the floor plan 12, an indication of the location and/or viewpoint of the player within the 3-D navigable environment, a compass illustrating at least one cardinal direction, GPS coordinates for the player in the 3-D navigable environment, as well as information about the particular view seen by the player at any time. This additional data may also include information about the particular room that is being viewed by the player (e.g., an indication of the room and/or its purpose, such as “Room 23A” or “Reception Area”), information about one or more objects within the room being viewed by the player (e.g., an indication as to whether an object is flammable and/or the material of the object, including an indication of its combustibility), information about a distance to a particular waypoint, a distance to a particular structure, and/or an area of the particular room in which the player resides in virtual space, as well as critical facility information (e.g., air handling systems, hazardous materials, communication info, fire systems, security personnel info, utility shut offs, utility hook ups, utility lines). One or more portions of this additional information may be revealed or hidden by the player and may be continuously updated as the player moves between rooms.

In Block 92, the digital representation is saved in an appropriate manner for one or more players to access, navigate, and interact with the digital representation from a user device. For example, the digital representation may be saved to the fileshare environment 34 or another networked mass storage device (not shown) that is accessible from a user device having an application installed thereon (e.g., a web browsers or dedicated IVIN system view) that receives data associated with the digital representation across the network 42 (e.g., a publically available network, such as the Internet, or a private network, such as an intranet). In some embodiments, the IVIN system is generally computing system platform independent. For example, the user device may navigate through the digital representation using a WINDOWS computing environment or a MAC computing environment. The user device may include at least one dedicated input device to capture player input (e.g., keyboard and/or mouse input) or, alternatively, a computing environment that uses an input and output device in combination to capture user input (e.g., a touch screen). Alternatively, the player may navigate through the indoor environment using a video game console, such as a video game console distributed by at least one of the following: Microsoft of Redmond, Wash.; Sony Corporation of America of New York, N.Y.; or Nintendo of America of Redmond, Wash. Thus, players may navigate through the indoor environment based on interaction with at least one user input device, interaction with a touch screen, or interaction with standard game controllers, depending upon the particular platform that the user is utilizing to view the indoor environment.

If necessary, one or more security measures may be incorporated such that the digital representation is accessible only to authorized players. As such, data for the IVIN system may be stored in a secure, remote location and accessed in real time as encrypted information available only to designated, or authorized, players, thus lowering the chances of security breaches. Additionally, in the alternative embodiments, the digital representation may be accessed by multiple players in separate locations, simultaneously, such that the multiple players may bring up the digital representation from their respective user devices. In turn, the user devices of the various players may provide information to the central location, at least some of which is provided to the other user devices of the other players.

In some embodiments, a central server for the IVIN system can maintain security over which players are allowed to access particular information. For example, players from Cincinnati, Ohio may not be permitted to access digital representations associated with indoor spaces from Florence, Ky., and vice-versa.

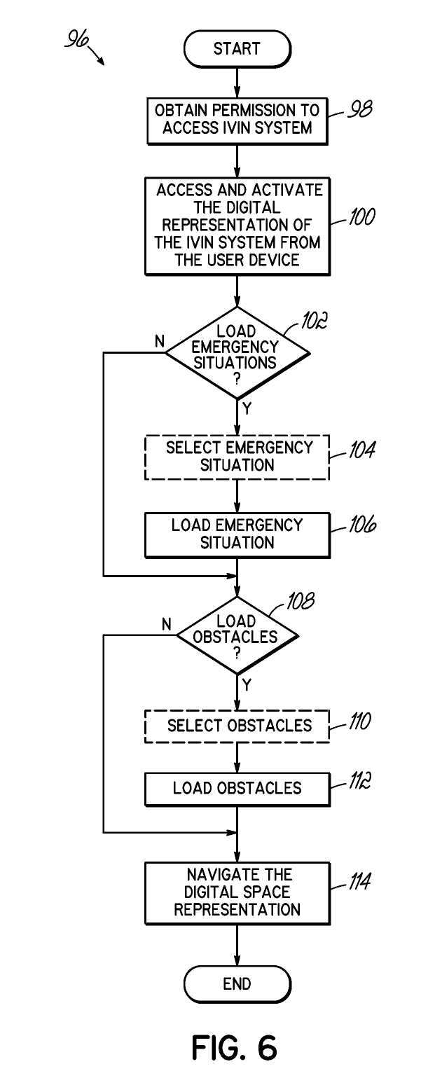

With the details of creating the IVIN system described in detail, reference is now made to FIG. 6, which is a flow chart illustrating one method 96 of using the IVIN system.

The method 96 begins with the player obtaining permission to access the IVIN system (Block 98). For example, the IVIN system may be used for training purposes and allow training and facility familiarization as well as post-event recovery and analysis. Thus, site-specific, single- and multi-player training exercises may be carried out within the digital representation without the need for the costly logistical nightmare of taking the actual site offline for training.

If permission is granted, then a password or other secure method is received and the player accesses and activates the digital representation from a suitable computer system or from their user device (Block 100). In some embodiments, the player navigates through the indoor environment using an application installed on the particular computing system utilized by the player. As such, the player activates the application and navigates throughout the indoor environment locally from the user device.

Depending on the level of permission acquired, the player may be able to configure the digital representation for a particular situation. For example, in one embodiment the player may be a first responder to an emergency situation. Accordingly, if the first responder desires to practice the emergency situation (i.e., simulated scenarios) with respect to the interior space associated with the digital representation (“Yes” branch of Inquiry 102), then the player may select the emergency situation (if permission to do so is granted; Block 104) and load the selected emergency situation (Block 106). Otherwise (“No” branch of Inquiry 102), the process continues.

To further create a realistic experience, one or more obstacles may be incorporated into the digital representation. Obstacles may include by-standers, hazards (fires, water from sprinklers, smoke, atmospheric conditions, chemical spills, overturned objects, etc.), which may hinder a response to the emergency situation. Accordingly, if the first responder desires to navigate the digital representation with an obstacle (“Yes” branch of Inquiry 108), then the player may select the obstacles (if permission to do so is granted; Block 110) and load the obstacles (Block 112). Otherwise (“No” branch of Inquiry 108), the process continues and the player navigates the digital representation (Block 114).

Navigation of the digital representation may include movement to particular areas within the digital representation with ease (e.g., teleport from one area to another), as well as experience a number of effects in the indoor environment. The player may be provided a line-of-sight perspective from wherever the player chooses to walk within the digital representation through the user device.

In some embodiments, the IVIN system is utilized to provide the player with an automatically updating emergency response system. For example, the player may be equipped with location determining devices and utilize a portable computing system (e.g., an arm or wrist-mounted computing system). Then, as the player moves through the digital representation, the IVIN system displays the player's location in the floor plan 12 displayed on the user device. If a multi-player exercise is carried out, then the information associated with the other players (for example, other first responders) may also be displayed. Further information with respect to the single- or multi-player exercise may also be displayed and, for example, may include player status (e.g., encountering an emergency), whether a player requires assistance, whether a particular room 18-32 (FIG. 2) has been checked and/or secured, and other emergency information (e.g., whether a person has been recovered or the emergency situation resolved).

Once the training has been completed, the player may end the method 96.

While the present invention has been illustrated by a description of the various embodiments, it is not the intention of the applicant to restrict or in any way limit the scope embodiments of the invention. Additional advantages and modifications will readily appear to those skilled in the art. For example, one having ordinary skill in the art will appreciate that persons may be removed from the images captured in the indoor environment, as well as objects that are unimportant, unnecessary, and/or transitory in nature (e.g., a movable cart in a room to deliver mail). Moreover, one having ordinary skill in the art will appreciate that the floor plan may be adjusted, as necessary, to take into account improvements and/or adjustments that are not reflected in architectural drawings or blueprints thereof. As such, the newest information about a particular indoor environment may be utilized.

Thus, the invention in its broader aspects is therefore not limited to the specific details, representative apparatus and method, and illustrative example shown and described. In particular, a person having ordinary skill in the art will appreciate that any of the blocks of the flowchart may be deleted, augmented, made to be simultaneous with another, combined, or be otherwise altered in accordance with the principles of the embodiments of the invention. Accordingly, departures may be made from such details without departing from the spirit or scope of applicants' general inventive concept.

While the present invention has been illustrated by a description of various embodiments, and while these embodiments have been described in some detail, they are not intended to restrict or in any way limit the scope of the appended claims to such detail. Additional advantages and modifications will readily appear to those skilled in the art. The various features of the invention may be used alone or in any combination depending on the needs and preferences of the user. This has been a description of the present invention, along with methods of practicing the present invention as currently known. However, the invention itself should only be defined by the appended claims.

What is claimed is:

1. A method of providing a navigable environment of an indoor space having a plurality of rooms, the plurality of rooms of the indoor space being mapped to a floor plan, the method comprising:
acquiring a plurality of images associated with the plurality of rooms of the indoor space;
creating at least two panoramic views of each of the plurality of rooms in the indoor space by combining at least a portion of the plurality of images;
rendering the at least two panoramic views into a model of the indoor space;
defining a three-dimensional model from the rendered model of the indoor space; and
graphically illustrating a three-dimensional navigable representation of the three-dimensional model of the indoor space with a graphics engine for a first user to navigate throughout the indoor space.

2. The method of claim 1, wherein rendering the at least two panoramic views further comprises:
rendering the panoramic views with the floor plan into the model.

3. The method of claim 1, further comprising:
defining a model of at least one object in the indoor space.

4. The method of claim 3, further comprising:
rendering a least a second portion of the plurality of images onto the model of the at least one object.

5. The method of claim 1, further comprising:
graphically illustrating the floor plan with the location of the viewpoint of the first user in the three-dimensional navigable representation of the rendered model.

6. The method of claim 5, further comprising:
graphically illustrating a location of a second user in the floor plan of the indoor environment.

7. The method of claim 5, further comprising:
graphically illustrating at least one of the plurality of rooms associated with the indoor space.

8. The method of claim 7, further comprising:
graphically illustrating a status associated with the at least one of the plurality of rooms.

9. The method of claim 7, further comprising:
graphically illustrating textual information associated with the at least one of the plurality of rooms.

10. The method of claim 1, further comprising:
graphically illustrating the location of the viewpoint of the first user in the three-dimensional navigable representation of the rendered model.

11. The method of claim 1, further comprising:
graphically illustrating textual information associated with the indoor space.

12. The method of claim 1, further comprising:
graphically illustrating a location of at least one utility associated with the indoor space.

13. A method of providing a navigable environment of an indoor space having a plurality of rooms, the plurality of rooms of the indoor space being mapped to a floor plan, the method comprising:
providing an indication of a first user to a computing system; and
in response to the first user being a valid user, graphically illustrating a three-dimensional navigable representation of a model of the indoor space with a graphics engine that includes at least two rendered panoramic views of the plurality of rooms, wherein the first user navigates throughout the indoor space.

14. The method of claim 13, further comprising:
graphically illustrating a model of at least one object in the indoor environment.

15. The method of claim 13, further comprising:
graphically illustrating the floor plan with the location of the viewpoint of the first user in the three-dimensional navigable representation of the rendered model.

16. The method of claim 15, further comprising:
graphically illustrating a location of a second user in the floor plan of the indoor space.

17. The method of claim 15, further comprising:
graphically illustrating at least one of the plurality of rooms associated with the indoor space.

18. The method of claim 17, further comprising:
graphically illustrating a status associated with the at least one of the plurality of rooms.

19. The method of claim 17, further comprising:
graphically illustrating textual information associated with the at least one of the plurality of rooms.

20. The method of claim 13, further comprising:
graphically illustrating the location of the viewpoint of the first user in the three-dimensional navigable representation of the rendered model.

21. The method of claim 13, further comprising:
graphically illustrating textual information associated with the indoor space.

22. The method of claim 13, further comprising:
graphically illustrating a location of at least one utility associated with the indoor space.

23. A method of combining a plurality of images into a panoramic image of an indoor space having a plurality of rooms, the plurality of rooms of the indoor space being mapped to a floor plan, the method comprising:
receiving a plurality of images associated with the plurality of rooms;
automatically determining, from information associated with the plurality of images, a subset of the plurality of images that can be utilized to create the panoramic image of at least one of the plurality of rooms;
automatically matching at least one feature in a first one of the plurality of images of the at least one of the plurality of rooms with at least one corresponding feature in a second one of the plurality of images of the at least one of the plurality of rooms; and
automatically merging the first and second one of the plurality of images.

24. The method of claim 23, wherein the information associated with the plurality of images includes at least one of a sequence indication for each of the plurality of images, an indication of a direction of view for each of the plurality of images, an indication of a particular room in which each of the plurality of images is captured, and an indication of camera settings utilized to capture the each of the plurality of images.

25. A method of providing a navigable environment of an indoor space having a plurality of rooms, the plurality of rooms of the indoor space being mapped to a floor plan, the method comprising:
graphically illustrating a three-dimensional navigable representation of a model of the indoor space with a graphics engine that includes at least two rendered panoramic views of the plurality of rooms, wherein a user navigates throughout the indoor space.

26. (canceled)

27. (canceled)

28. A method of training a first person with respect to an event within an indoor space, the method comprising:
loading a three-dimensional navigable representation of the indoor space having a plurality of rooms, the plurality of rooms of the indoor space being mapped to a floor plan, the three-dimensional navigable representation created by a method comprising:
graphically illustrating the three-dimensional navigable representation of a model of the indoor space with a graphics engine that includes at least two rendered panoramic views of the plurality of rooms; and
simulating the event within the indoor space.

29. The method of claim 28, further comprising:
monitoring at least one condition of the first person within the indoor space, the at least one condition selected from a location of the first person and a status of the first person.

30. The method of claim 29, further comprising:
monitoring at least one condition of a second person within the indoor space, the at least one condition selected from a location of the second person and a status of the second user.

31. The method of claim 28, further comprising:
monitoring a status of the simulated event; and
in response to the monitoring, incorporating one or more obstacles into the indoor space.

32. The method of claim 31, wherein the obstacle includes an environmental condition, an atmospheric condition, or one or more by-standers, or a combination thereof.

33. The method of claim 28, wherein the event includes a medical emergency, an environmental emergency, a security emergency, or a terrorist incident, or a combination thereof.

34. The method of claim 33, wherein the situation includes a threat of the situation.

35. The method of claim 28, wherein the first person is involved with the events of associated with normal operation of the indoor space, involved with events of restoring normal operation of the indoor space, or involved with events that are unrelated to the normal operation of the indoor space.

36. A method of creating a model of an indoor space for entertaining one or more interactive players, the method comprising:
loading a three-dimensional navigable representation of the indoor space having a plurality of rooms, the plurality of rooms of the indoor space being mapped to a floor plan, the three-dimensional navigable representation created by a method comprising:
graphically illustrating the three-dimensional navigable representation of a model of the indoor space with a graphics engine that includes at least two rendered panoramic views of the plurality of rooms; and
simulating the one or more interactive players within the indoor space such that the one or more interactive players may interact with other ones of the one or more interactive players within the indoor space or directly with the indoor space.

37. The method of claim 36, further comprising:
monitoring at least one condition of the at least one interactive player within the indoor space, the at least one condition selected from a location of the at least one interactive player and a status of the at least one interactive player.
